(19) United States
(12) Patent Application Publication
(10) Pub. No.: US 2010/0199022 A1
(43) Pub. Date: Aug. 5, 2010

(54) INFORMATION ACCESS METHOD WITH SHARING MECHANISM AND COMPUTER SYSTEM

(75) Inventors: Chun-Hsu Chen, Taipei Hsien (TW); Chung-Ching Huang, Taipei Hsien (TW); Chin-Han Chang, Taipei Hsien (TW)

Correspondence Address: J C PATENTS, 4 VENTURE, SUITE 250, IRVINE, CA, 92618, US

(73) Assignee: VIA TECHNOLOGIES, INC., Taipei Hsien (TW)

(21) Appl. No.: 12/401,133

(22) Filed: Mar. 10, 2009

(30) Foreign Application Priority Data
Feb. 4, 2009 (TW) 98103501

(51) Int. Cl. G06F 12/02

(52) U.S. Cl. 711/103; 711/E12.008

(57) ABSTRACT

An information access method and a computer system are provided. The computer system includes a system management bus (SMBus), a non-volatile memory, a plurality of hardware devices, a chipset, and a CPU. The hardware devices have a plurality of specific recognition information. The CPU performs a configuration process on the hardware devices through the chipset according to the standard for a SMBus protocol, so as to distribute a plurality of memory spaces in the non-volatile memory to the hardware devices. The hardware devices share the SMBus for accessing the plurality of specific recognition information in the memory spaces.

### CROSS-REFERENCE TO RELATED APPLICATION

This application claims the priority benefit of Taiwan application serial no. 98103501, filed on Feb. 4, 2009. The entirety of the above-mentioned patent application is hereby incorporated by reference herein and made a part of specification.

### BACKGROUND OF THE INVENTION

1. Field of the Invention

The present invention relates to an information access technology; more particularly, the present invention relates to an information access method with a sharing mechanism and a computer system.

2. Description of the Related Art

Along with the coming of an information era, in order to enhance the information security management, the hardware devices (for example, the network card and the USB control card) on the motherboard of the computer system respectively need an independent EEPROM for accessing the desired specific recognition information thereof. For example, the network card needs to access only a 6-byte MAC address in an EEPROM having a predetermined memory capacity such as 256-kbyte, while the USB control card needs to access only a 16-byte UUID in an another EEPROM having a predetermined memory capacity such as 256-kbyte. Accordingly, it can be seen that the resources are mostly wasted because an EEPROM having a large memory capacity is merely used for storing a few bytes information therein. Moreover, the number of the desired EEPROMs on the motherboard is getting more and more when the number of the hardware devices on the motherboard which all need to access the specific recognition information is getting more and more. Furthermore, in the age of the electronic products having increased functions, reduced size, and low price, the portable electronic system products such as the notebook, the mini-computer and the cellular phone are increasingly popularized. Accordingly, if the usage of the EEPROMs with extremely low gross profit can be reduced by the system manufacturers, the cost be reduced, and the market competitiveness of their products can also be promoted.

Besides, in general, the hardware devices, such as the network card and the USB control card which are all on the motherboard of the conventional computer system, respectively access the desired specific recognition information thereof in different EEPROMs through the internal integrated circuit (I²C) bus. However, since the I²C bus is situated in the operating status whether the computer system is in a normal mode or in a power-saving mode, the power is consumed at all time. Therefore, the concept of green energy cannot be implemented.

### SUMMARY OF THE INVENTION

The present invention provides a computer system including a system management bus (SMBus), a non-volatile memory, a plurality of hardware devices, a chipset, and a CPU. The non-volatile memory and the hardware devices are coupled to the SMBus, and the hardware devices have a plurality of specific recognition information. The chipset is coupled to the hardware devices. The CPU is coupled to the chipset and used for performing a configuration process on the hardware devices through the chipset according to a standard for a SMBus protocol, so as to distribute a plurality of memory spaces in the non-volatile memory to the hardware devices.

According to an exemplary embodiment of the present invention, the hardware devices share the SMBus for accessing the plurality of specific recognition information in the memory spaces.

The present invention also provides an information access method which is suitable for being applied to a computer system including a non-volatile memory, a CPU, a chipset, and a plurality of hardware devices, wherein the hardware devices have a plurality of specific recognition information. The information access method includes performing a configuration process on the hardware devices through the CPU and the chipset according to a standard for a bus protocol, so as to distribute a plurality of memory spaces in the non-volatile memory to the hardware devices; and sharing the bus to access the plurality of specific recognition information of the hardware devices in the memory spaces.

According to an exemplary embodiment of the present invention, the standard for the bus protocol is a standard for a system management bus (SMBus) protocol.

The present invention also provides a computer system including a bus, a non-volatile memory, a plurality of hardware devices, a chipset, and a CPU. The non-volatile memory and the hardware devices are coupled to the bus, and the hardware devices have a plurality of universal unique identifiers (UUIDs). The chipset is coupled to the hardware devices. The CPU is coupled to the chipset and used for performing a configuration process on the hardware devices through the chipset according to a standard for the bus protocol, so as to distribute a plurality of memory spaces in the non-volatile memory to the hardware devices.

According to an exemplary embodiment of the present invention, the hardware devices share the bus for accessing the UUIDs in the memory spaces, wherein the bus is a system management bus (SMBus).

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a computer system according to an exemplary embodiment of the present invention.

FIGS. 2 and 3 respectively show a diagram of a computer system according to another exemplary embodiment of the present invention.

FIG. 4 is a flow chart of an information access method according to an exemplary embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

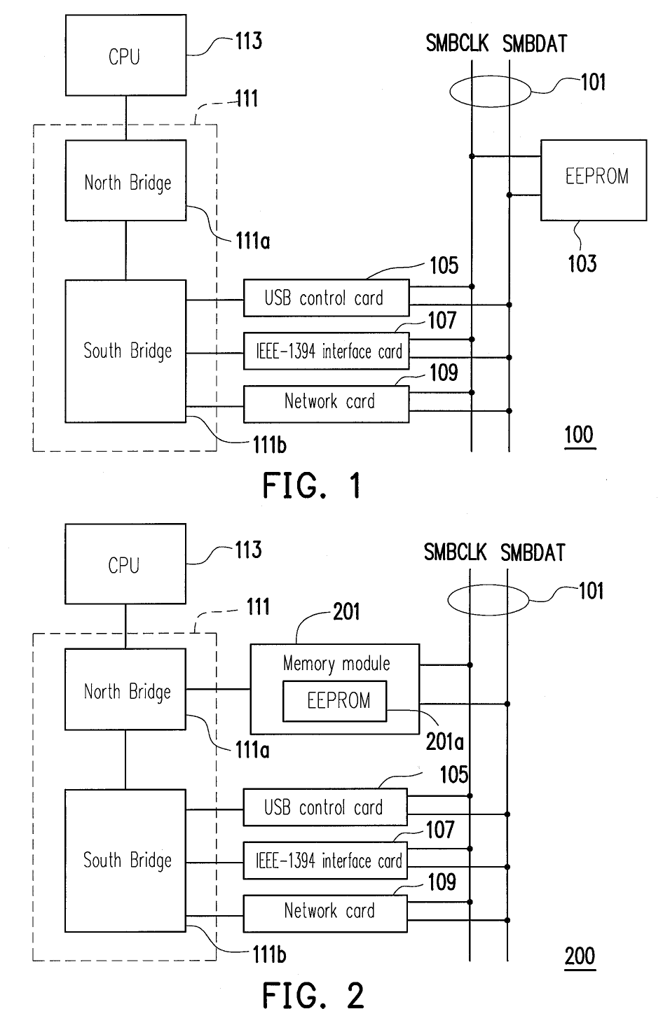

FIG. 1 is a diagram of a computer system according to an exemplary embodiment of the present invention. Referring to FIG. 1, the computer system 100 includes a SMBus 101, a non-volatile memory 103 (for example, an EEPROM) independently existing in the computer system 100, a plurality of hardware devices (for example, the USB control card 105, the IEEE-1394 interface card 107, and the network card 109 (but not limited thereto) which are all on a motherboard (not shown)), a chipset 111 including a North Bridge 111a and a South Bridge 111b, and a CPU 113.

In the exemplary embodiment, the USB control card 105, the IEEE-1394 interface card 107 and the network card 109 respectively need a specific recognition information so as to enhance the information security management. For example, the USB control card 105 and the IEEE-1394 interface card 107 respectively need a 16-byte UUID, and the network card 109 needs a 6-byte MAC address (also referred to as a physical address).

From the above, the number of the desired EEPROMs equipped on the motherboard is getting more and more when the number of the hardware devices on the motherboard which all need to access the specific recognition information is getting more and more. Accordingly, the cost is increased, and such a design is very uneconomical. Besides, in general, the hardware devices, such as the network card and the USB control card, which are all on the motherboard of the conventional computer system, respectively access the desired specific recognition information thereof in different EEPROMs through the internal integrated circuit (I²C) bus. However, since the I²C bus is situated in the operating status whether the computer system is situated in a normal mode or in a power-saving mode, the power is consumed at all time. Therefore, the concept of green energy cannot be implemented.

Accordingly, in order to reduce the cost, increase the economic benefit of design, and fully implement the concept of green energy, the exemplary embodiment discloses sharing the SMBus 101 and the non-volatile memory 103.

Accordingly, through the CPU 113 a configuration process can be performed on the USB control card 105, the IEEE-1394 interface card 107 and the network card 109 through the chipset 111 (i.e. the North Bridge 111a and the South Bridge 111b) according to a standard for a SMBus 101 protocol when the computer system 100 is initialized, so as to distribute a plurality of memory spaces in the non-volatile memory 103 to the USB control card 105, the IEEE-1394 interface card 107 and the network card 109.

Thereupon, the USB control card 105, the IEEE-1394 interface card 107 and the network card 109 respectively obtain a memory space, including the start address and the end address, in the non-volatile memory 103 for accessing, and share the SMBus 101 according to the standard for the SMBus 101 protocol, such that the USB control card 105, the IEEE-1394 interface card 107 and the network card 109 respectively and commonly access the desired specific recognition information in a single non-volatile memory 103. Therefore, comparing the exemplary embodiment with the conventional art, the hardware devices that need to access the specific recognition information are not respectively equipped with an EEPROM in the exemplary embodiment, such that the cost is reduced, and such a design is very economical.

Besides, in the exemplary embodiment, any external device (for example, the PCI device) can timely and respectively access the desired specific recognition information of the USB control card 105, the IEEE-1394 interface card 107 and the network card 109 through the SMBus 101 when the computer system 100 is situated in the power-saving mode (for example, S3 sleep state defined by ACPI). In other words, the SMBus 101 may be situated in the operating status when the computer system 100 is situated in the power-saving mode and a certain external device respectively needs to access the desired specific recognition information of the USB control card 105, the IEEE-1394 interface card 107 and the network card 109 at this time. Therefore, the power is not consumed at all time, and the concept of green energy can be fully implemented accordingly.

FIG. 2 is a diagram of a computer system according to another exemplary embodiment of the present invention. Referring to FIG. 2, the computer system 200 includes a system management bus (SMBus) 101, a memory module 201, a plurality of hardware devices (for example, the USB control card 105, the IEEE-1394 interface card 107 and the network card 109 (but not limited thereto) which are all on a motherboard (not shown)), a chipset 111 including a North Bridge 111a and a South Bridge 111b, and a CPU 113.

In the exemplary embodiment, the memory module 201 is a dynamic random access memory (DRAM) module, and a part of the DRAM module is a non-volatile memory 201a. A serial presence detect (SPD) code is recorded in the non-volatile memory 201a, wherein the SPD code is used for storing the configuration information of the DRAM module. However, the SPD code is generally known by one having ordinary skill in the art; accordingly, it is not further described herein. Moreover, the non-volatile memory is also used for storing the specific recognition information of the hardware devices 105, 107 and 109 to completely replace independent EEPROMs.

In addition, the USB control card 105, the IEEE-1394 interface card 107 and the network card 109 respectively need a specific recognition information so as to enhance the information security management. For example, the USB control card 105 and the IEEE-1394 interface card 107 respectively need a 16-byte UUID, and the network card 109 needs a 6-byte MAC address (also referred to as a physical address). The exemplary embodiment supposes that the valid and remaining memory capacity of the non-volatile memory 201a is capable of respectively accessing the desired specific recognition information of the USB control card 105, the IEEE-1394 interface card 107 and the network card 109.

From the above, the number of the desired EEPROMs equipped on the motherboard is getting more and more when the number of the hardware devices on the motherboard which all need to access the specific recognition information is getting more and more. Accordingly, the cost is increased, and such a design is very uneconomical. Besides, in general, the hardware devices, such as the network card and the USB control card, which are all on the motherboard of the conventional computer system, respectively access the desired specific recognition information thereof in different EEPROMs through the internal integrated circuit (I²C) bus. However, since the I²C bus is situated in the operating status whether the computer system is situated in a normal mode or in a power-saving mode, the power is consumed at all time. Therefore, the concept of green energy cannot be implemented.

Accordingly, in order to reduce the cost, increase the economic benefit of design, and fully implement the concept of green energy, the exemplary embodiment discloses sharing the SMBus 101 and the non-volatile memory 201a. Beside, in the exemplary embodiment, suppose the valid and remaining memory capacity of the non-volatile memory 201a is capable of respectively accessing the desired specific recognition information of each of the hardware devices, i.e. the USB control card 105, the IEEE-1394 interface card 107 and the network card 109.

After the computer system 200 is activated, the computer operating system performs a configuration process on the USB control card 105, the IEEE-1394 interface card 107 and the network card 109, so as to distribute a plurality of memory spaces in the non-volatile memory 201a to the USB control card 105, the IEEE-1394 interface card 107 and the network card 109. Accordingly, after the computer system 200 is activated, the computer system 200 retrieves the data (i.e. the MAC address and the UUIDs) in specific positions of the non-volatile memory 201a rather than requesting the data of the MAC address and the UUIDs from the USB control card 105, the IEEE-1394 interface card 107 and the network card 109.

Thereupon, the USB control card 105, the IEEE-1394 interface card 107 and the network card 109 respectively obtain a memory space, including the start address and the end address, in the non-volatile memory 201a for accessing, and share the SMBus 101 according to a standard for a SMBus 101 protocol, such that the USB control card 105, the IEEE-1394 interface card 107 and the network card 109 respectively and commonly access the desired specific recognition information in a single non-volatile memory 201a. Therefore, comparing the exemplary embodiment with the conventional art, the hardware devices that need to access the specific recognition information are not respectively equipped with an EEPROM in the exemplary embodiment, such that the cost is reduced, and such a design is very economical.

Besides, in the exemplary embodiment, any external device (for example, the PCI device) can timely and respectively access the desired specific recognition information of the USB control card 105, the IEEE-1394 interface card 107 and the network card 109 through the SMBus 101 when the computer system 200 is situated in the power-saving mode (for example, S3 sleep state defined by ACPI). In other words, the SMBus 101 may be situated in the operating status when the computer system 200 is situated in the power-saving mode and a certain external device respectively needs to access the desired specific recognition information of the USB control card 105, the IEEE-1394 interface card 107 and the network card 109 at this time. Therefore, the power is not consumed at all time, and the concept of green energy can be fully implemented accordingly.

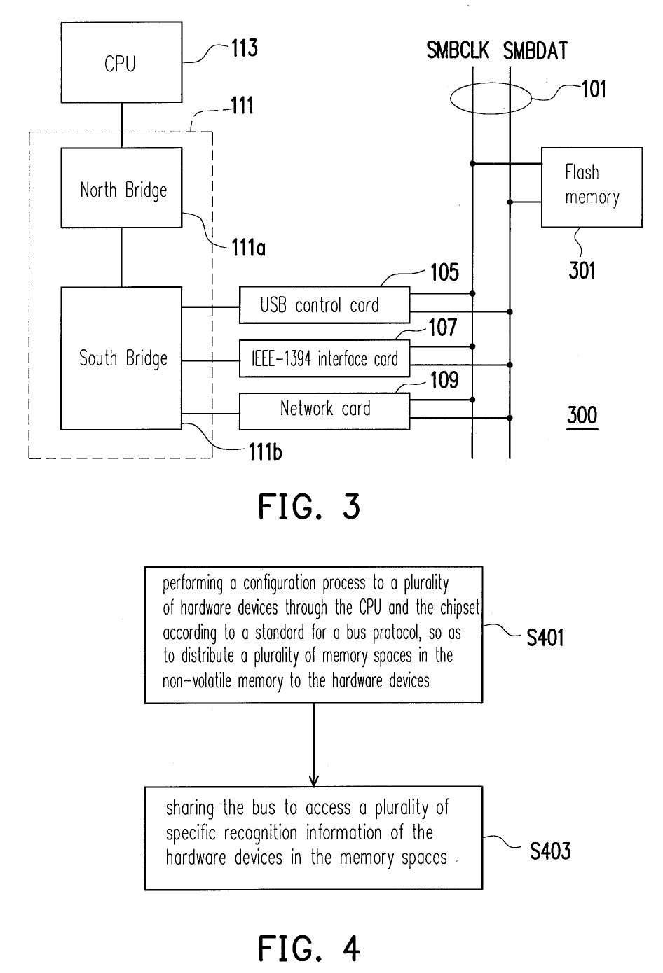

FIG. 3 is a diagram of a computer system according to another exemplary embodiment of the present invention. Referring to FIG. 3, the computer system 300 includes a SMBus 101, a non-volatile memory 301 (for example, a flash memory) independently existing in the computer system 300, a plurality of hardware devices (for example, the USB control card 105, the IEEE-1394 interface card 107 and the network card 109 (but not limited thereto) which are all on a motherboard (not shown)), a chipset 111 including a North Bridge 111a and a South Bridge 111b, and a CPU 113.

In the exemplary embodiment, the USB control card 105, the IEEE-1394 interface card 107 and the network card 109 respectively need a specific recognition information so as to enhance the information security management. For example, the USB control card 105 and the IEEE-1394 interface card 107 respectively need a 16-byte UUID, and the network card 109 needs a 6-byte MAC address (also referred to as a physical address).

From the above, the number of the desired EEPROMs equipped on the motherboard is getting more and more when the number of the hardware devices on the motherboard which all need to access the specific recognition information is getting more and more. Accordingly, the cost is increased, and such a design is very uneconomical. Besides, in general, the hardware devices, such as the network card and the USB control card, which are all on the motherboard of the conventional computer system, respectively access the desired specific recognition information thereof in different EEPROMs through the internal integrated circuit (I²C) bus. However, since the I²C bus is situated in the operating status whether the computer system is situated in the normal mode or in the power-saving mode, the power is consumed at all time. Therefore, the concept of green energy cannot be implemented.

Accordingly, in order to reduce the cost, increase the economic benefit of design, and fully implement the concept of green energy, the exemplary embodiment teaches sharing the SMBus 101 and the non-volatile memory 301.

Accordingly, the CPU 113 performs a configuration process on the USB control card 105, the IEEE-1394 interface card 107 and the network card 109 through the chipset 111 (i.e. the North Bridge 111a and the South Bridge 111b) according to a standard for a SMBus 101 protocol when the computer system 300 is initialized, so as to distribute a plurality of memory spaces in the non-volatile memory 301 to the USB control card 105, the IEEE-1394 interface card 107 and the network card 109.

Thereupon, the USB control card 105, the IEEE-1394 interface card 107 and the network card 109 respectively obtain a memory space, including the start address and the end address, in the non-volatile memory 301 for accessing, and share the SMBus 101 according to the standard for the SMBus 101 protocol, such that the USB control card 105, the IEEE-1394 interface card 107 and the network card 109 respectively and commonly access the desired specific recognition information in a single non-volatile memory 301. Therefore, comparing the exemplary embodiment with the conventional art, the hardware devices that need to access the specific recognition information are not respectively equipped with an EEPROM in the exemplary embodiment, such that the cost is reduced, and such a design is very economical.

Besides, in the exemplary embodiment, any external device (for example, the PCI device) can timely and respectively access the desired specific recognition information of the USB control card 105, the IEEE-1394 interface card 107 and the network card 109 through the SMBus 101 when the computer system 300 is situated in the power-saving mode (for example, S3 sleep state defined by ACPI). In other words, the SMBus 101 may be situated in the operating status when the computer system 300 is situated in the power-saving mode and a certain external device respectively needs to access the desired specific recognition information of the USB control card 105, the IEEE-1394 interface card 107 and the network card 109 at this time. Therefore, the power is not consumed at all time, and the concept of green energy can be fully implemented accordingly.

Furthermore, even though all of the hardware devices are all disposed/equipped on the motherboard, the present invention is not limited thereto. In other exemplary embodiments of the present invention, the hardware devices can be a network communication device (for example, a HUB, a modem, etc.), an USB control device and an IEEE-1394 interface device which all need to access the specific recognition information, but the present invention is also not limited thereto, and such varied exemplary embodiments would fall in the scope of the present invention. In addition, the present invention can be applied to any product or system which needs to integrate the specific recognition information. For example, any of the all-in-one desktop PC, the notebook, the mini-computer and the portable device, such as the cellular phone, can achieve the efficiency of reducing the cost and saving power by applying the present invention.

In addition, in other exemplary embodiments of the present invention, it is possible to merely enhance the information security management of the USB control card 105 and the IEEE-1394 interface card 107, and such varied exemplary embodiments would fall in the scope of the present invention.

FIG. 4 is a flow chart of an information access method according to an exemplary embodiment of the present invention. Referring to FIG. 4, the information access method of the exemplary embodiment is suitable for being applied to a computer system including a non-volatile memory, a CPU, a chipset and a plurality of hardware devices, wherein the hardware devices have a plurality of specific recognition information.

The information access method of the present invention includes performing a configuration process on the hardware devices through the CPU and the chipset according to a standard for a bus protocol (for example, the standard for the SMBus protocol), so as to distribute a plurality of memory spaces in the non-volatile memory to the hardware devices (in step S401); and sharing the bus to access the plurality of specific recognition information of the hardware devices in the memory spaces (in step S403).

In summary, comparing the present invention with the conventional art, the information access method and the computer system provided by the present invention do not respectively equip the hardware devices which all need to access the specific recognition information with an EEPROM. On the contrary, the information access method and the computer system thereof provided by the present invention share the SMBus and a single non-volatile memory (for example, the EEPROM or the flash memory) additionally disposed/equipped on the motherboard or the EEPROM of the memory module itself to reduce the cost, increase the economic benefit of design, and fully implement the concept of green energy (i.e. power saving).

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A computer system, comprising:
a system management bus (SMBus);
a non-volatile memory coupled to the SMBus;
a plurality of hardware devices coupled to the SMBus, the hardware devices having a plurality of specific recognition information;
a chipset coupled to the hardware devices; and
a CPU coupled to the chipset for performing a configuration process on the hardware devices through the chipset according to a standard for a SMBus protocol, so as to distribute a plurality of memory spaces in the non-volatile memory to the hardware devices,
wherein the hardware devices share the SMBus for accessing the plurality of specific recognition information in the memory spaces

2. The computer system according to claim 1, wherein an external device timely accesses the plurality of specific recognition information through the SMBus when the computer system is situated in a power saving mode.

3. The computer system according to claim 1, wherein the non-volatile memory independently exists in the computer system.

4. The computer system according to claim 3, wherein the non-volatile memory comprises an electrically erasable programmable read-only memory (EEPROM) or a flash memory.

5. The computer system according to claim 3, wherein the chipset comprises:
a North Bridge coupled to the CPU; and
a South Bridge coupled to the North Bridge and the hardware devices.

6. The computer system according to claim 1, further comprising a memory module.

7. The computer system according to claim 6, wherein the non-volatile memory is an EEPROM in the memory module.

8. The computer system according to claim 7, wherein the chipset comprises:
a North Bridge coupled to the CPU and the memory module; and
a South Bridge coupled the North Bridge and the hardware devices.

9. The computer system according to claim 1, wherein the hardware devices at least comprise a network card, an USB control card, and an IEEE-1394 interface card which are on a motherboard of the computer system.

10. The computer system according to claim 1, wherein the hardware devices at least comprise a network communication device, an USB control device, and an IEEE-1394 interface device.

11. An information access method, suitable for being applied to a computer system comprising a non-volatile memory, a CPU, a chipset, and a plurality of hardware devices, the hardware devices having a plurality of specific recognition information, the information access method comprising:
performing a configuration process on the hardware devices through the CPU and the chipset according to a standard for a bus protocol, so as to distribute a plurality of memory spaces in the non-volatile memory to the hardware devices; and
sharing the bus to access the plurality of specific recognition information of the hardware devices in the memory spaces.

12. The information access method according to claim 11, wherein the standard for the bus protocol is a standard for a system management bus (SMBus) protocol.
